(19) United States
(12) Patent Application Publication
(10) Pub. No.: US 2007/0025798 A1
(43) Pub. Date: Feb. 1, 2007

(54) Soap dispenser with replaceable fragrance in a bag

(76) Inventor: Linda Dale Platt, Little Rock, AR (US)

Correspondence Address: LINDA D. PLATT, 5020 W. 30TH ST., LITTLE ROCK, AR, 72204, US

(21) Appl. No.: 11/495,929

(22) Filed: Jul. 29, 2006

Related U.S. Application Data
(60) Provisional application No. 60/704,312, filed on Aug. 1, 2005.

(51) Int. Cl. B43K 25/00; A47K 7/02

(52) U.S. Cl. 401/52; 401/201

(57) ABSTRACT

A combination decorative soap dispenser with replaceable fragrance comprises upstanding shortened decorative container of suitable dimensions for storing a plurality of solid soap arranged one on another defined by a peripheral wall with a base portion at a bottom end, the peripheral wall and base portions are of the same color print with a pattern to coordinate with the container and cover portions and a removable decorative cover portion is at an open top end of the shortened container to permit insertion and removal of soap. The cover portion comprises a void to hold the fragrance-emitting device with a releasable attachment to replace the fragrance-emitting device when dried out and when attached permits the attachments and the fragrance-emitting device to be hidden from view.

### CROSS-REFERENCE TO RELATED APPLICATIONS

This application claims the benefit of provisional patent application Ser. No. 60/704,312, filed Aug. 1, 2005 by the present inventor.

### FEDERALLY SPONSORED RESEARCH

Not Applicable

### SEQUENCE LISTING OR PROGRAM

Not Applicable

### BACKGROUND OF THE INVENTION

1. Field of Invention

The present invention relates to personal hygiene, more particularly, to a combination decorative soap dispensers with replaceable fragrance emitting device in order to function in the emission of fragrances and to facilitates the dispensing and storage of a plurality of solid soap at the site of use which are to be dispensed when needed, while at the same time covering the unused soap from view to provide a aesthetically pleasing appearance, an upstanding shortened decorative container of suitable dimensions defined by a peripheral wall with a base portion at a bottom end, the peripheral wall and base portion are of the same color print with a pattern, and a decorative removable cover portion of the same dimension with a fragrance emitting device holder is at an open top end to permit insertion and removal of soap, the cover portion comprises a void to hold a fragrance emitting device with a releasable attachment means to replace the fragrance emitting device when dried out and when attached permits the attachments and the fragrance-emitting device to be hidden from view.

In general, a first field of use of the disclosed invention is by homeowners of larger families and frequently attended bathrooms as the most likely benefactors of the unique advantages of the present invention. However, many other fields, such as restrooms in office buildings, public buildings, restaurants, hotels, movie theaters, churches, department stores, and kitchens could find potentially beneficial uses of the invention.

Thus, it can be seen that the potential fields of use for this invention are myriad, and the particular preferred embodiments described herein are in no way meant to limit the use of the invention to the particular field chosen for exposition of the details of the invention.

A comprehensive listing of all the possible fields to which this invention may be applied is limited only by the imagination and is, therefore, not provided herein. Some of the more obvious applications are mention in the interest of providing a full and complete disclosure of the unique properties of this previously known article of manufacture. It is to be understood from the outset that the scope of this invention is not limited to these fields or to the specific example of potential uses presented herein.

### BACKGROUND OF THE INVENTION

2. Prior Art

There is a considerable amount of prior art on soap dispensers and holders however, there is no prior art that disclosed or suggests applicant's combination decorative soap dispensers with replaceable fragrance as disclosed and claimed herein. The actual function of the combination soap dispenser with a replaceable fragrance will not be readily apparent at first glance.

As most people are aware, a soap dispenser is a necessary accessory in virtually every bathroom. However, many people wish that there were a more convenient way for the soap dispensers to be less visibly intrusive, yet always readily accessible.

Most combination soap dispensers are located remote from locations where fresh soap is stored such as cabinets under the sink or linen closets or other closets. In industrial and commercial restrooms, liquid soap is usually provided within the dispensers or by mounting a plurality of dispensers near the sink.

The present invention is directed to improving combination devices for storing a plurality of solid soap in a manner, which is convenient, economical, simple and easy to use, provides a void for a fragrance emitting device, plus a matching decorative combination toilet paper roll dispenser with replaceable fragrance.

For example U.S. Pat. No. 4,630,794 to Ross, discloses a bar soap holder and dispenser wherein the bar soap is deposited in the top of the holder, directed toward a draining tray and dispended by pushing on the front of the holder, forcing the bar soap to an opening in the bottom of the holder and releasing the bar soap to a users' hand below.

U.S. Pat. No. 5,984,440 to Watson discloses a soap bar holder with a tray for cleaning, the invention comprising a singular housing with a partitioned interior, a sliding tray in the bottom of the housing and a singular cover on the front of the housing. U.S. Pat. No. 6,343,845 to Woodard, discloses a multiple bar soap storage dispenser allowing for the storage and drainage of multiple soap bars in the bath or shower are in which multiple soap bars are placed in individual pivoting soap compartments accessible by opening the pivoting compartment removing the bar soap and replacing the bar soap in the container for drainage and drying of the bar soap until its next use.

Although the above mentioned prior arts constructions are more than adequate for the basic purpose and function for which they have been specifically designed, they are deficient with respect to their failure to provide a simple, efficient, easy to clean, free standing combination decorative soap dispenser with replaceable fragrance emitting device holder, plus a matching decorative aesthetically pleasing combination toilet paper roll dispenser with replaceable fragrance emitting device holder that coordinates with the decor of any room.

U.S. Pat. No. 6,729,506 to Brown, discloses a method of facilitating replacement of a supply of air freshener every time a supply of soap is replaced, including the steps of providing a supply of air freshener, providing a supply of soap and joining the supply of soap and the supply of air freshener. Another aspect of this method is a method of packaging a supply unit including providing a supply of soap and a supply of air freshener and connecting the supply soap and the supply of air freshener in a manner such that when the supply of soap is removed from a dispenser, the supply of air freshener is removed from the dispenser as well.

Another aspect is a supply unit for the dual dispenser including a receptacle, a supply of soap within the receptacle, and a supply of air freshener connected to or secured within the receptacle. Yet another aspect of the invention is a dual dispenser including a mechanism for dispensing the soap, a mechanism for actuating the dispensement of soap, a mechanism for accelerating the dispensement of air freshener and a mechanism for actuating the mechanism for accelerating the dispensement of air freshener.

Although the above described patent discloses a method facilitating the replacement of a supply of air freshener every time a supply of soap is replaced is deficient with respect to failure to provide a simple, efficient, easy to clean, free standing decorative aesthetically pleasing soap dispenser with replaceable fragrance emitting device holder, plus a matching decorative aesthetically pleasing toilet paper roll dispenser with replaceable fragrance emitting device hold that coordinates with the décor of any room. For hygiene purpose, some people may be reluctant in handling the mechanism to dispense, to actuating, and to accelerate the soap and air freshener if the dispenser is part a public washroom. Furthermore, some users of public washrooms may not be familiar with the movable parts, and the mechanisms methods of such an apparatus, in which case periodic manual attendance is still required.

The soap storage device of the present invention can be used as a dispenser or alternatively, for storage of one solid soap or a plurality of solid soap. The decorative container portion color coordinates with the peripheral wall, the base, and the decorative cover portion and the decorative cover portion provides a void to hold a fragrance emitting device in order to function of emission of fragrances with releasable attachment means to replace the emitting device when dried out.

The soap storage device of the present invention is designed to enclose and thereby protect one or more solid soap from inadvertent contact with water or other liquids, which could damage the soap usefulness. The design of the removable decorative cover portion, which provides an emission of fragrances of the present invention, makes it easier to grip the decorative cover portion and displaces in order to gain access to the soap stored therein.

There has existed a longstanding need for a new and improved type of free standing combination solid soap dispensing arrangement which is not only readily moveable about the home to a location where most needed, but also an arrangement whose purpose and functions are not readily apparent, and the provision of such a construction is a stated objective of the present invention.

### SUMMARY OF THE INVENTION

The present invention is a combination decorative soap dispenser with replaceable fragrance emitting device to function in the emission of fragrances comprises an upstanding shortened decorative container of suitable dimensions for storing a plurality of solid soap arranged one on another defined by a peripheral wall with a base portion at a bottom end and a decorative removable cover portion of the same dimensions is at an open top end to permit insertion and removal of soap, at the same time providing an enticing aesthetically pleasing appearance while permitting the soap to be hidden from view when not in use. The decorative cover portion comprises a void to hold a fragrance-emitting device with a releasable attachment means to replace the fragrance-emitting device when dried out and permitting the device to be hidden from view.

Accordingly, it is a principal object of the present invention to provide a aesthetically pleasing color coordinated combination decorative soap dispensers with replaceable fragrance that has a matching aesthetically pleasing color coordinated combination toilet paper roll dispenser with replaceable fragrance that will overcome the shortcomings of the prior art devices.

Another principal object of the present invention is to provide a void within the cover portion to hold a fragrance-emitting device with a releasable attachment means to replace the fragrance emitting device when dried out.

Another object of the present invention is to provide a soap dispenser with replaceable fragrance that can be placed on a counter top to more a plurality of solid soap for future use.

Another object of the present invention is to provide a soap dispenser with replaceable fragrance, while able to store a number of solid soap, still takes up but a minimum of space.

Another object of the present invention is to provide the consumer the inconvenience of running out of soap during use when displayed on the sink near the site of use.

Another object of the present invention is to provide a soap dispenser with replaceable fragrance that does not contain any electrically or operated mechanism.

Another object of the present invention is helping reduce the manpower required to refill the soap when needed.

Another object of the present invention is to provide a combination soap dispensers with replaceable fragrance that can be given any color external finish desired, since the present invention is not limited to construction from any one kind of material or fabric.

Another object of the present invention is to provide coordination of a designated group of bathroom or kitchen accessories that through it's overall color, print, design, pattern, or fabric will provide a common theme and appearance.

Another object of the present invention is to provide at least one item selected from the group to coordinate with the present invention.

Another object of the present invention is to provide the ability to be disposed alone or without any item select from the group.

A further object of the present invention is to provide simplicity and convenience.

A still further object of the present invention is to provide a color coordinated decorative aesthetically pleasing combination soap dispensers with replaceable fragrance emitting device holder that is economical to manufacture.

Yet another object of the present invention is to provide a color coordinated decorative combination soap dispensers with replaceable fragrance, which is simple to clean and maintain in a sanitary condition.

Yet, another object of the present invention is to provide a bag for comfort to carry when purchased.

In addition to present invention is intended to be color coordinated with other generally fixed kitchen accessories and appliances, as well as bathroom accessories.

These and other objects of the present invention will become readily apparent upon further review of the present specification and drawings.

### BRIEF DESCRIPTION OF THE DRAWINGS

A preferred embodiment of the present invention will now described in detail having reference to the accompanying drawings in which:

FIG. 1 is a perspective front view of one embodiment of the combination soap dispenser and an elevation front view of the decorative cover portion in accordance with the present invention; and

FIG. 2 is an elevation view of the soap storage and dispensing device, partly fragmented, of the soap dispenser loaded with soap; and

FIG. 3 is a perspective view of one embodiment of the soap dispenser in accordance with the present invention without the removable cover portion; and

FIG. 4 are a perspective back view of one embodiment of the soap dispenser and an elevation back view of the decorative cover portion in accordance with the present invention.

### DRAWING—REFERENCE NUMERALS

10 combination soap dispenser

12 decorative container portion

14 peripheral wall

16 removable decorative cover portion

18 void

20 hook

20a loop

22 base portion

24 open top end

26 a gathering

28 yarn

30 ribbon

32 a knot of yarn

34 a knot of ribbon

36 innerface

36a opposite inner face

38 face side up

40 reverse side

42L left side

42R right side

44 bottom end

46 fabric

48 adhesive

### DESCRIPTION OF PREFERRED EMBODIMENTS

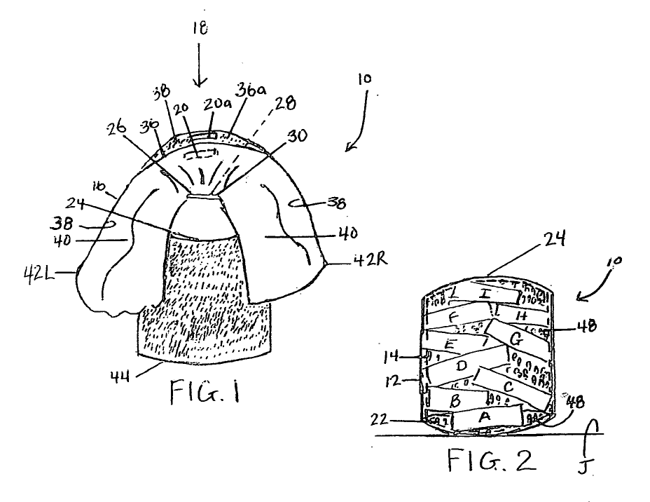

According to the drawings and, more particularly, to FIG. 1, is a perspective front view of a combination soap dispenser and an elevation front view of the cover portion in accordance with the present invention is generally shown at 10. The soap dispenser 10 comprises an upstanding shortened decorative container portion 12 of suitable dimensions having a peripheral wall 14 and base portion 22 (FIG. 2). The container portion 12 is secured to a bottom end 44. The base portion 22 may enclose a circular disk and fabric of slightly smaller dimensions not shown in order to provide the soap dispenser 10 with stability when disposed on a counter top J (FIG. 2). The peripheral wall 14 and base 22 (FIG. 2) are of the same print with a pattern held in place by an adhesive 48 secure base 22 to internal bottom end 44 (FIG. 2) which coordinates with the dispenser 10 and an elevation front view of the removable decorative cover portion 16 of the same dimensions of shortened container 12 is placed on an open top end 24 of the container portion 12. The decorative cover portion 16 comprises a rectangular shaped fabric 46 having a void 18 within the cover portion 16. The fabric 46 may enclose a circular disk of the same dimension as shortened container 12 and a square piece of fabric secure the fabric around the edges of the disk not shown place in the center of fabric 46 face side up 38 in order to provide the cover portion 16 with stability when placed on the open top end 24 having a gathering 26 permitting the disk and fabric to be hidden from view held by a string of yarn 28 tied in a knot 32 in back of the gathering 26 shown in FIG. 4 is covered by an elongated ribbon 30 like member wrapped around the gathering 26 tied in a knot 34 in back of gathering 26 shown in FIG. 4, to create a void with releasable attachments 20 and 20a allowing a fragrance emitting device not shown to be held or replaced. The loop 20 is secured to inner face up 36 and hook 20a is secured to opposite inner face 36a of face side up 38 of fabric 46 when attached permits attachments and the fragrance-emitting device to be hidden from view. Flip the face side up 38 on left side 42L and flip the face side up 38 on the right side 42R of fabric 46 back revealing reverse side 40 of fabric 46 permitting fabric 46 to hang over the top end 24 of container portion 12.

The removable decorative cover portion 16 of the same dimension is designed to sit firmly on the open top end 24 of the container portion 12 permitting the soap to be hidden from view. It is pointed out that there are various methods for connecting the cover portion 16 to the container portion 12 (e.g. mating threading and tapping, snap-fit devices, etc. It is observed that a locking mechanism may be provided although not shown, such as to grant access to the container portion 12 to maintenance staff, in the case of use in a public washroom.

The peripheral wall 14 and base portion 22 (FIG. 2) could be of different materials and fabrics, colors, prints, patterns, or designs.

The contain portion 12 and the cover portion 16 could be of durable plastic, metal, ceramic, or other materials and fabrics not mentioned.

Referring now to FIG. 2, the soap dispenser 10 is shown enclosing soap A, B, C, D, E, F, G, H, and I. The soap may be typical solid soap, different shapes and sizes. The soap is inserted in the container portion 12 from the open top end 24 arranged one on another. It is observed that the dispenser 10 is simply disposed on counter top J, although it could be permanently secured thereto in public washroom uses. This allows for the dispenser 10 used in households to be moved around.

The peripheral wall 14 and base portion 22 not shown are of the same print with a pattern to color coordinate with the decorative container portion 10 and the cover portion 16 as shown in FIG. 1.

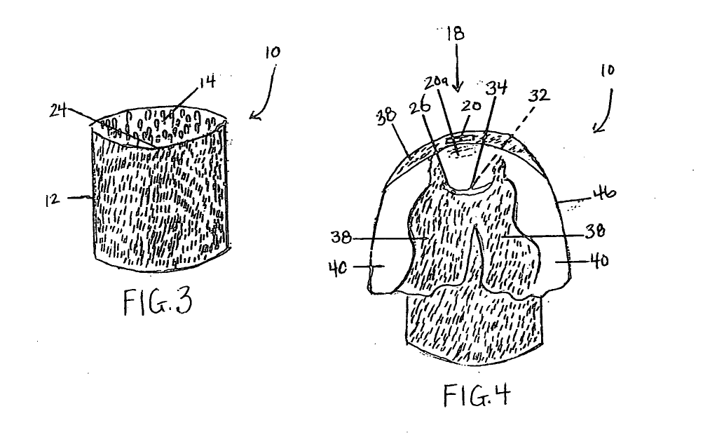

The container portion 12 may be sized to accommodate various amounts of soap. As illustrated, the dispenser 10 encloses bars solid soap. Soap A, B. C, D, E, F, G, H, and I, may be discarded by gripping and lifting upward removing the cover portion 16 (FIG. 3) from the container portion 12 to permit insertion and removal of soap.

FIG. 3 the soap dispenser in accordance with the present invention is generally shown at 10 without the cover portion 16 shown in FIG. 1. It is observed that the peripheral wall 14 of the container portion 12 is partially visible such as to determine whether it need to be refilled. The container portion 12 may be various materials, fabrics, and colors to coordinate with the cover portion 16 shown in FIG. 1, to suit the decoration of any household.

FIG. 4 a perspective back view of a combination soap dispenser and an elevation back view of the decorative cover portion in accordance with the present invention is generally shown at 10. It is observed that the knot of yarn 32 is covered by the knot of ribbon 30 like member both wrapped around a gathering 26 of fabric 46 revealing permitting the knot 32 to be hidden from view and the elevation back view of the decorative cover portion 16 comprises the releasable attachments 20 and 20a which are unattached to permit insertion of a fragrance emitting device not shown to be held or replaced in void 18 to function in the emission of fragrances.

The container portion 12, the peripheral wall 14, the base portion 22 and the removable covered portions 16 are to coordinate with one another.

The container portion 12 and cover portion 16 of the present invention could be of the same materials, fabric, color, print, pattern, or design. However, the container portion 12, and the cover portion 16 of the present invention could be of different fabrics, colors, print, patterns, or designs and other materials and fabrics not mentioned.

It is suggested that the container portion 12 may be used storage and dispensing of other toiletries not mention.

It is also suggested that container portion 12 when used in a kitchen setting provides storage and dispensing of cookies or other kitchen items not mentioned.

The fabric could be terrycloth, one hundred percent cotton, combed cotton, woven cotton, white or colored, solid or pattern or designs, kitchen towels, velour, or fleece and other fabrics not mentioned.

It is within the ambit of the present invention to cover any obvious modifications of the embodiments described herein, provided such modifications fall within the scope of the appended claims.

I claim:

1. A combination soap dispenser for a plurality of solid soap with a replaceable fragrance emitting device comprising: an upstanding shortened color coordinated decorative container of suitable dimensions for storing a plurality of solid soap arranged one on another defined by a peripheral wall and a base portion at a bottom end thereof, said peripheral wall and said base portion being of the same color print with a pattern therein, and a said removable decorative cover portion of the same dimensions is at a open top end of shortened container to permit insertion and removal of soap comprises a void to hold a said fragrance-emitting device and a said to replace the said fragrance-emitting device when dried out and when attached permits the said attachments and said fragrance-emitting device to be hidden from view:
said peripheral wall and said base portion are of the said same print with a pattern therein;
the dispenser according to claim 1, wherein said base portion comprises a said disk and said fabric for adding stability to said dispenser.

2. The dispenser according to claim 1, wherein said removable decorative cover portion comprising fabric with a said void therein for facilitating insertion and replacement of a said fragrance emitting device, a said releasable attachment secured to said fabric, and a said ribbon like member at a said gathering therein;
the dispenser according to claim 1, wherein said base portion comprise a said disk and fabric for adding stability to said dispenser.

3. The dispenser according to claim 1, wherein said container is adapted for receiving nine solid soap or more.
